(19) United States
(12) Patent Application Publication
(10) Pub. No.: US 2016/0162187 A1
(43) Pub. Date: Jun. 9, 2016

(54) Storage System And Method For Processing Writing Data Of Storage System

(71) Applicant: The-AIO Co., Ltd., Seongnam-si (KR)

(72) Inventor: Jae-Soo LEE, Hwaseong-si (KR)

(73) Assignee: THE-AIO CO., LTD., Seongnam-si, KG (KR)

(21) Appl. No.: 14/785,073

(22) PCT Filed: Jan. 29, 2014
(86) PCT No.: PCT/US2014/000867

§ 371 Date: Oct. 16, 2015

(30) Foreign Application Priority Data
Apr. 17, 2013 (KR) 10-2013-0042152

(51) Int. Cl. G06F 3/06

(52) U.S. Cl. CPC G06F 3/061; G06F 3/0688; G06F 3/0655; G06F 2212/7201

(57) ABSTRACT

A method of processing write-data in a storage system includes an operation of storing write-data related to a write-request in a data I/O queue when the write-request is generated by a file system, an operation of classifying data stored in the data I/O queue into a full storage logical page and a partial storage logical page, an operation of transmitting data related to the full storage logical page to a storage device in response to the write-request, and An operation of leaving data related to the partial storage logical page in the data I/O queue in response to the write-request.

### BACKGROUND

1. Technical Field

Example embodiments relate generally to a semiconductor memory system. More particularly, embodiments of the present inventive concept relate to a storage system including a host device and a storage device (e.g., a flash memory device) and a method of processing write-data in a storage system.

2. Description of the Related Art

A semiconductor memory device may be classified into two types (i.e., a volatile memory device and a non-volatile memory device) according to whether data can be retained when power is not supplied. In addition, a NAND flash memory device is widely used as the non-volatile memory device because the NAND flash memory device can be manufactured smaller in size while having higher capacity. Thus, a storage device such as the NAND flash memory device (e.g., a solid state drive (SSD)) has been replacing a hard disk drive (HDD). Generally, the storage device includes at least one NAND flash memory and a storage controller for controlling the NAND flash memory and the host device includes a file system and a host controller for interacting with the storage controller.

Recently, attempts to distribute a function of a flash translation layer (FTL) between the storage device and the host device are being made, where the flash translation layer supports the file system by controlling a read operation, a write operation, an erase operation, a merge operation, a copy-back operation, a compaction operation, a garbage collection operation, a wear leveling operation, an address mapping operation, and the like for the NAND flash memory. For example, the host controller may include a host flash translation layer and the storage controller may include a storage flash translation layer.

Meanwhile, since a read operation and a write operation are performed by a block unit (e.g., 1 KB, 2 KB, 4 KB, etc) in the host device, a size of a host logical page that the host device uses is set based on a size of a block of the file system. On the other hand, a read operation and a write operation are performed by a specific unit (e.g., more than 16 KB) (i.e., referred to as a storage logical page) that is a multiple of a physical page of the NAND flash memory in the storage device. Recently, a size of the storage logical page of the storage device is getting bigger to enhance continuous write performance of the storage device and reduce a size of a mapping table. Therefore, the size of the storage logical page is usually bigger than the size of the host logical page.

As the size of the storage logical page is bigger than the size of the host logical page, the host device sends a plurality of write-requests to the storage device to complete a write operation performed on the same storage logical page of the storage device. This may cause performance degradation and lifetime shortening of the NAND flash memory due to characteristics of the NAND flash memory (i.e., the NAND flash memory cannot perform an overwrite operation, the NAND flash memory performs a read operation and a write operation by a page unit, and the NAND flash memory performs an erase operation by a block unit).

### SUMMARY

Some example embodiments provide a method of processing write-data in a storage system that can prevent a plurality of write-requests from being sent to a storage device to complete a write operation performed on the same storage logical page of the storage device.

Some example embodiments provide a storage system employing the method of processing the write-data in the storage system.

According to an aspect of example embodiments, a method of processing write-data in a storage system may include an operation of storing write-data related to a write-request in a data input/output (I/O) queue when the write-request is generated by a file system, an operation of classifying data stored in the data I/O queue into a full storage logical page and a partial storage logical page, an operation of transmitting data related to the full storage logical page to a storage device in response to the write-request, and an operation of leaving data related to the partial storage logical page in the data I/O queue in response to the write-request.

In example embodiments, the method may further include an operation of transmitting the data related to the full storage logical page to the storage device without storing the data related to the full storage logical page in the data I/O queue when the write-data includes the full storage logical page.

In example embodiments, the method may further include an operation of transmitting remaining-data related to a storage logical page that is determined as the partial storage logical page in a previous write-request to the storage device when the write-data includes no data related to the storage logical page.

In example embodiments, the full storage logical page may be distinguished from the partial storage logical page based on a size of a storage logical page that is set by the storage device.

In example embodiments, the method may further include an operation of transmitting the data stored in the data I/O queue to the storage device when a flush-request is generated by the file system.

According to an aspect of example embodiments, a storage system may include a storage device including at least one flash memory and a storage controller that controls the flash memory based on a storage flash translation layer, and a host device including a file system and a host controller that interacts with the storage controller. Here, the host controller may store write-data related to a write-request in a data input/output (I/O) queue when the write-request is generated by the file system, may classify data stored in the data I/O queue into a full storage logical page and a partial storage logical page, may transmit data related to the full storage logical page to the storage device in response to the write-request, and may leave data related to the partial storage logical page in the data I/O queue in response to the write-request.

In example embodiments, the host controller may transmit the data related to the full storage logical page to the storage device without storing the data related to the full storage logical page in the data I/O queue when the write-data includes the full storage logical page.

On example embodiments, the host controller run transmit remaining-data related to a storage logical page that is determined as the partial storage logical page in a previous write-request to the storage device when the write-data includes no data related to the storage logical page.

In example embodiments, the host controller may distinguish the full storage logical page from the partial storage logical page based on a size of a storage logical page that is set by the storage device.

In example embodiments, the host controller may transmit the data stored in the data I/O queue to the storage device when a flush-request is generated by the file system.

Since a size of a storage logical page of a storage device is bigger than a size of a host logical page of a host device, the host device may send, in response to a write-request generated by a file system included in the host device, a plurality of write-requests to the storage device to complete a write operation performed on the same storage logical page of the storage device.

As a size of a storage logical page of a storage device is bigger than a size of a host logical page of a host device, the present inventive concept (i.e., a storage system according to example embodiments and a method of processing write-data in a storage system according to example embodiments) may gather (or, collect) write-data related to a write-request generated by a file system, which is included in the host device, in the size of the storage logical page of the storage device by using a data input/output (I/O) queue of a host controller, which is included in the host device, and may transmit gathered write-data to the storage device. Thus, the present inventive concept may enhance performance of the storage system and may increase lifetime of the storage system by preventing (or, reducing) unnecessary write-request transmission and by reducing the number of times a full merge operation is performed when a garbage collection operation is performed by a storage flash translation layer.

### BRIEF DESCRIPTION OF THE DRAWINGS

Illustrative, non-limiting example embodiments will be more clearly understood from the following detailed description taken in conjunction with the accompanying drawings.

FIG. 1 is a block diagram illustrating a storage system according to example embodiments.

FIG. 2A is a diagram illustrating an example in which a host controller operates in response to a write-request generated by a file system in a conventional storage system.

FIG. 2B is a diagram illustrating an example in which a host controller operates in response to a write-request generated by a file system in the storage system of FIG. 1.

FIG. 3 is a diagram illustrating an example in which a host controller operates in response to a flush-request generated by a file system in the storage system of FIG. 1.

FIG. 4 is a flowchart illustrating a method of processing write-data in a storage system according to example embodiments.

### DETAILED DESCRIPTION OF THE EMBODIMENTS

Hereinafter, embodiments of the present inventive concept will be explained in detail with reference to the accompanying drawings.

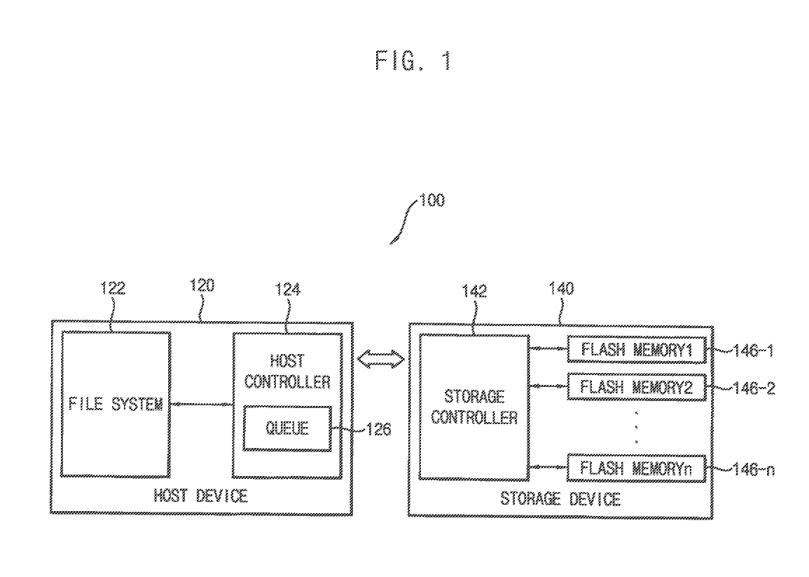

FIG. 1 is a block diagram illustrating a storage system according to example embodiments.

Referring to FIG. 1, the storage system 100 may include a host device 120 and a storage device 140.

The storage device 140 may be a NAND flash memory device. For example, the storage device 140 may be implemented as a solid state drive (SSD), a secure digital (SD) card, a universal flash storage (UFS), an embedded multi media card (eMMC), a compact flash (CF) card, a memory stick, an eXtreme Digital (XD) picture card, etc. However, the storage device 140 is not limited thereto. The storage device 140 may include first through (n)th flash memories 146-1 through 146-n, where n is an integer greater than or equal to 1, and a storage controller 142. The storage controller 142 may interact with the first through (n)th flash memories 146-1 through 146-n. Here, the storage controller 142 may control the first through (n)th flash memories 146-1 through 146-n. The storage device 140 may perform a read operation, a write operation, an erase operation, a merge operation, a copy-back operation, a compaction operation, a garbage collection operation, a wear leveling operation, and the like by supporting the file system 122 based on a flash translation layer (i.e., the storage controller 142 executes the flash translation layer implemented as a software program). It should be understood that the storage device 140 may further include other hardware and/or software components in addition to the storage controller 142 and the first through (n)th flash memories 146-1 through 146-n.

The host device 120 may include the file system 122 and the host controller 124. The host controller 124 may interact with the file system 122. The file system 122 may generate an I/O command for the host controller 124 by a block unit (hereinafter, referred to as a host logical page). The host controller 124 may process the I/O command of the file system 122 by generating an I/O command for the storage device 140 by a sector unit (e.g., 512 byte).

The host controller 124 may include a data I/O queue 126. Here, the data I/O queue 126 is a temporary storage space for gathering and processing continuous write-requests generated by the file system 122 if the continuous write-requests are related to the same storage logical page. Thus, it should be understood that the data I/O queue 126 represents a data structure that acts (or, functions) as a temporary storage space (e.g., a linked list, a priority queue, etc). A size of the storage logical page is usually bigger than a size of the host logical page. Thus, a plurality of write-requests related to the same storage logical page may be sent from the host device 120 to the storage device 140 to complete a write operation performed on the same storage logical page. This may cause performance degradation and lifetime shortening of the storage system 100. To overcome this problem, the host controller 124 of the host device 120 may include the data I/O queue 126.

In addition, the host controller 124 may classify all data stored in the data I/O queue 126 into a full (or, complete) storage logical page and a partial (or, incomplete) storage logical page. Here, among storage logical pages stored in the data I/O queue 126 (or, the temporary storage space), a storage logical page of which all data exist in the data I/O queue 126 may be referred to as the full storage logical page, and a storage logical page of which a portion of data does not exist in the data I/O queue 126 may be referred to as the partial storage logical page. In an example embodiment, a storage logical page may be determined as the full storage logical page when data corresponding to an end part of the storage logical page exists in the data I/O queue 126. On the other hand, a storage logical page may be determined as the partial storage logical page when data corresponding to an end part of the storage logical page does not exist in the data I/O queue 126. In another example embodiment, a storage logical page may be determined as the full storage logical page when a size of data related to the storage logical page stored in the data I/O queue 126 is equal to a size of the storage logical page. On the other hand, a storage logical page may be determined as the partial storage logical page when a site of data related to the storage logical page stored in the data I/O queue 126 is smaller than a size of the storage logical page. For this operation, the host controller 124 may compare a size of data related to a storage logical page stored in the data I/O queue 126 with a size of the storage logical page.

Specifically, when the full storage logical page exists in the data I/O queue 126, the host controller 124 of the host device 120 may transmit data related to the full storage logical page to the storage device 140. On the other hand, when the partial storage logical page exists in the data I/O queue 126, the host controller 124 of the host device 120 may not transmit data related to the partial storage logical page to the storage device 140. In other words, data related to the partial storage logical page may remain in the data I/O queue 126 to wait for a next write-request. Thus, in the next write-request remaining-data related to the partial storage logical page may be merged with other data related to the partial storage logical page when the other data related to the partial storage logical page exist in the data I/O queue 126. Here, when the remaining-data of the partial storage logical page and the other data of the partial storage logical page constitute all data of the partial storage logical page, the partial storage logical page may be determined as a full storage logical page in the next write-request. As a result, in the next write-request, the remaining-data of the partial storage logical page and the other data of the partial storage logical page (i.e., data related to the full storage logical page) may be transmitted from the host device 120 to the storage device 140. In brief, if a portion of write-data related to a current write-request and a portion of remaining-data related to a previous write-request belong to one storage logical page, the portion of the write-data related to the current write-request and the portion of the remaining-data related to the previous write-request may be merged. Then, it may be determined whether the storage logical page (i.e., merged data stored in the data I/O queue 126) is a full storage logical page.

In some example embodiments, the host controller 124 may transmit data related to a full storage logical page to the storage device 140 when the host controller 124 can promptly transmit the data related to the full storage logical page to the storage device 140. In some example embodiments, the host controller 124 may transmit data related to a partial storage logical page to the storage device 140 when it is anticipated that additional data related to the partial storage logical page does not exist in a next write-request. For example, when write-data related to a current write-request includes a full storage logical page, data related to the hill storage logical page may not need to wait for a next write-request. Thus, the host controller 124 may transmit the data related to the full storage logical page to the storage device 140 without storing the data related to the full storage logical page in the data I/O queue 126. For example, when write-data related to a current write-request does not include data related to a storage logical page determined as a partial storage logical page in a previous write-request (i.e., stored in the data I/O queue 126), it may be very likely that write-data related to a next write-request includes no data related to the partial storage logical page. Thus, the host controller 124 may transmit the data related to the partial storage logical page to the storage device 140 without waiting for the next write-request. In some example embodiments, the host controller 124 may remerge data related to full storage logical pages as one I/O request to transmit remerged data related to the full storage logical pages to the storage device 140.

In addition, the host controller 124 of the host device 120 may transmit all data stored in the data I/O queue 126 to the storage device 140 when the file system 122 generates a flush-request to complete a processing of the write-data.

The host controller 124 should be interpreted as a program that processes (or, controls), using the data I/O queue 126, the write-data to be transmitted from the file system 122 of the host device 120 to the storage device 140 by a unit of a storage logical page. For example, the host controller 124 may be implemented in a device driver, a flash translation layer included in the device driver, or a program that performs the same (or, similar) function as the flash translation layer. In an example embodiment, the host controller 124 including the data I/O queue 126 may be implemented in a device driver that does not include a host flash translation layer. Thus, the host controller 124 may process (or, controls) the write-data to be transmitted from the file system 122 of the host device 120 to the storage device 140 by a unit of a storage logical page. In another example embodiment, the host controller 124 including the data I/O queue 126 may be implemented in a host flash translation layer included in a device driver. Thus, the host controller 124 may process (or, controls) the write-data to be transmitted from the file system 122 of the host device 120 to the storage device 140 by a unit of a storage logical page.

It should be understood that the host device 120 may further include other hardware and/or software components in addition to the file system 122 and the host controller 124 and the host controller 124 may farther include other hardware and/or software components in addition to the data I/O queue 126.

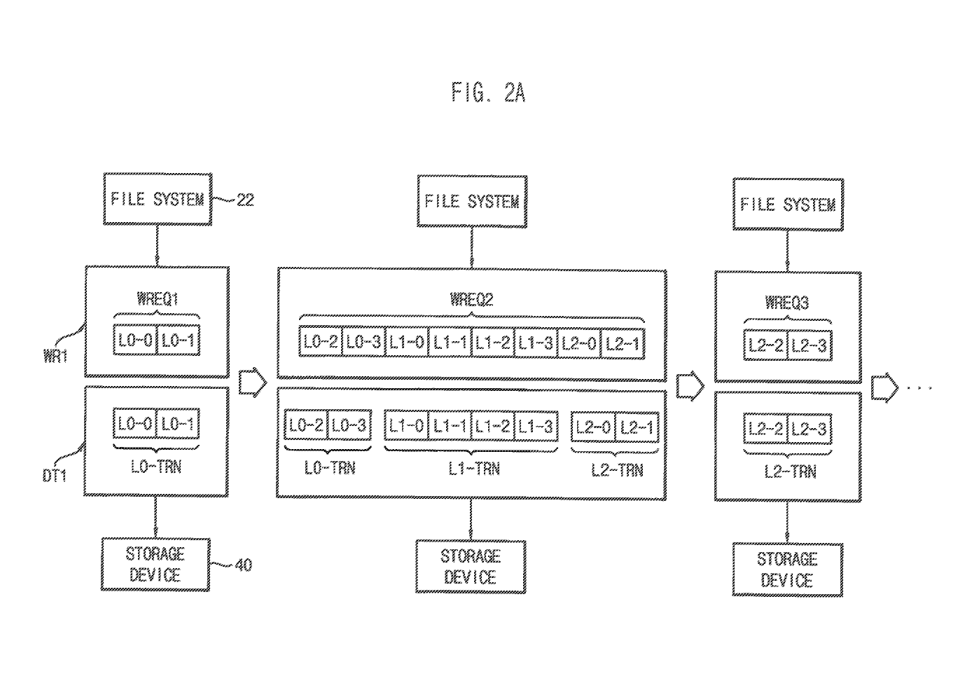

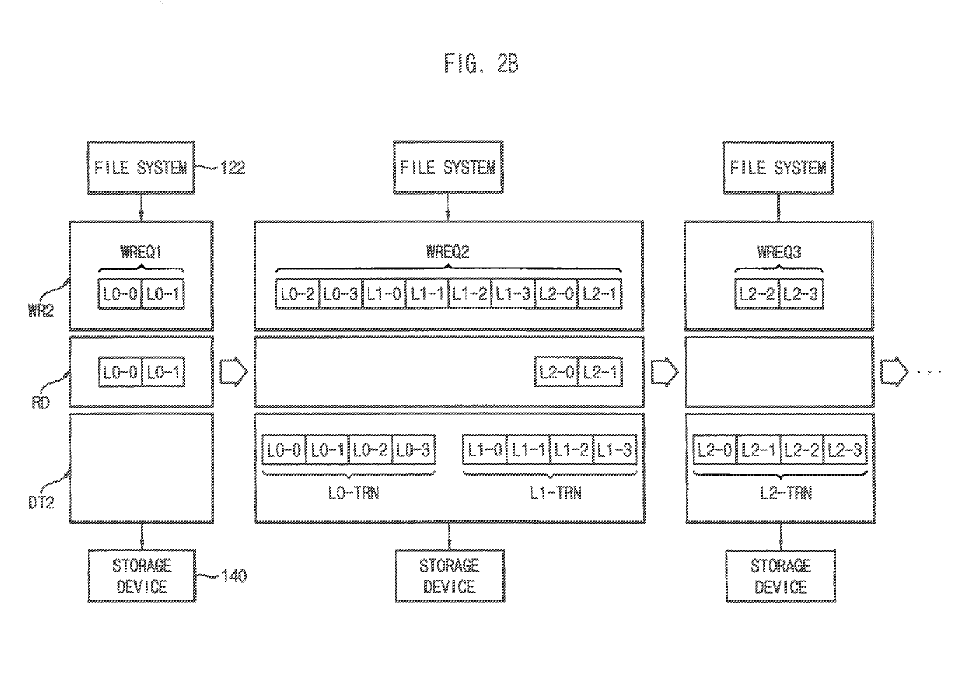

FIG. 2A is a diagram illustrating an example in which a host controller operates in response to a write-request generated by a file system in a conventional storage system. FIG. 2B is a diagram illustrating an example in which a host controller operates in response to a write-request generated by a file system in the storage system of FIG. 1.

Referring to FIGS. 2A and 2B, an effect of the present inventive concept (i.e., a write-data transmission manner of a host controller 124) is illustrated. Specifically, FIG. 2A shows that the host controller 24 that does not include a data I/O queue processes a write-request generated by the file system 22. FIG. 2B shows that the host controller 124 that includes the data I/O queue 126 processes a write-request generated by the file system 122. In FIGS. 2A and 2B, a size of a storage logical page is four times as big as a size of a host logical page. For example, the size of the host logical page may be 4 KB and the size of the storage logical page may be 16 KB. In FIGS. 2A and 2B, it is assumed that the file system 122 generates three continues write-requests (i.e., a first write-request WREQ1 for L0-0 and L0-1, a second write-request WREQ2 for L0-2, L0-3, L1-0, L1-1, L1-2, L1-3, L2-0, and L2-1, and a third write-request WREQ3 for L2-2 and L2-3) to perform write operations on storage logical pages L0, L1, and L2. Here, Lx denotes a storage logical page and Lx-y denotes a (y)th host logical page for the storage logical page Lx, where x and y are integers greater than or equal to 0.

As illustrated in FIG. 2A, the host controller 24 that does not include the data I/O queue may receive a write-request from the file system 22 and then may promptly transmit write-data related to the write-request generated by the file system 22 (i.e., referred to as transmission-data) to the storage device 40. In FIG. 2A, WR1 denotes the write-data related to the write-request generated by the file system 22 and DT1 denotes the transmission-data transmitted to the storage device 40. For example, when the first write-request WREQ1 for L0-0 and L0-1 is generated by the file system 22, where a size of the first write-request WREQ1 is two times as big as a size of the host logical page, the host controller 24 may transmit the transmission-data including L0-0 and L0-1 to the storage device 40 (i.e., indicated by L0-TRN) although the transmission-data including L0-0 and L0-1 is a partial storage logical page. Next, when the second write-request WREQ2 for L0-2, L0-3, L1-0, L1-1 L1-2, L1-3, L2-0, and L2-1 is generated by the file system 22, where a size of the second write-request WREQ2 for L0-2, L0-3, L1-0, L1-1, L1-2, L1-3, L2-0, and L2-1 is eight times as big as the size of the host logical page, the host controller 24 may transmit the transmission-data including L0-2, L0-3, L1-0, L1-1, L1-2, L1-3, L2-0, and L2-1 to the storage device 40 (i.e., indicated by L0-TRN, L1-TRN, and L2-TRN). Subsequently, when the third write-request WREQ3 for L2-2 and L2-3 is generated by the file system 22, where a size of the third write-request WREQ3 for L2-2 and L2-3 is two times as big as the size of the host logical page, the host controller 24 may transmit the transmission-data including L2-2 and L2-3 to the storage device 40 (i.e., indicated by L2-TRN). In brief, the host controller 24 may send two write-requests to the storage device 40 to complete a write operation performed on the storage logical page L0 and may send two write-requests to the storage device 40 to complete a write operation performed on the storage logical page L2. Thus, when the host controller 24 that does not include the data 170 queue is used, a plurality of write-requests may be sent to the storage device 40 in response to a write-request received from (or, generated by) the file system 22 to complete a write operation performed on the same storage logical page of the storage device 40. This may cause performance degradation and lifetime shortening of the storage system.

On the other hand, as illustrated in FIG. 2B, the host controller 124 including the data 170 queue 126 may prevent a plurality of write-requests from being sent to the storage device 140 to complete a write operation performed on the same storage logical page of the storage device 140. Specifically, the host controller 124 may receive a write-request from the file system 122 and may store write-data related to the write-request in the data I/O queue 126. Then, the host controller 126 may classify all data stored in the data I/O queue 126 into a full storage logical page and a partial storage logical page, may transmit data related to the full storage logical page (i.e., referred to as transmission-data) to the storage device 140, and may leave data related to the partial storage logical page (i.e., referred to as remaining-data) in the data I/O queue 126 (i.e., may not transmit data related to the partial storage logical page to the storage device 140). In FIG. 2B, WR2 denotes the write-data related to the write-request generated by the file system 122, DT2 denotes the transmission-data transmitted to the storage device 140, and RD denotes the remaining-data stored in the data I/O queue 126 after the data related to the full storage logical page is transmitted to the storage device 140. As described above, the host controller 124 may use the data I/O queue 126. In a situation illustrated in FIGS. 2A and 2B (i.e., when a size of the storage logical page is four times as big as a size of the host logical page), when the first write-request WREQ1 for L0-0 and L0-1 is generated by the file system 122, where a size of the first write-request WREQ1 for L0-0 and L0-1 is two times as big as the size of the host logical page, the host controller 124 may store write data related to the first write-request WREQ1 for L0-0 and L0-1 in the data I/O queue 126. However, the host controller 124 may not transmit the write-data related to the first write-request WREQ1 for L0-0 and L0-1 to the storage device 140 because a full storage logical page does not exist in the data I/O queue 126. That is, in order to process all data related to the same storage logical page at one time, the host controller 124 may not transmit data related to a partial storage logical page to the storage device 140 until at least one additional write-request for other data to which the partial storage logical page is related is received from the file system 122. Next, when the second write-request WREQ2 for L0-2, L0-3, L1-0, L1-1, L1-2, L1-3, L2-0, and L2-1 is generated by the file system 122, where a size of the second write-request WREQ2 for L0-2, L0-3, L1-0, L1-1, L1-2, L1-3, L2-0, and L2-1 is eight times as big as the size of the host logical page, the host controller 124 may store the write-data including L0-2, L0-3, L1-0, L1-1, L1-2, L1-3, L2-0, and L2-1 in the data I/O queue 126. Here, since a first full storage logical page (i.e., L0-0, L0-1, L0-2, and L0-3) and a second full storage logical page (i.e., L1-0, L1-1, L1-2, and L1-3) exist in the data I/O queue 126, the host controller 124 may fetch (or, dequeue) the transmission-data including L0-0, L0-1 L0-2, and L0-3 and the transmission-data including L1-0, L1-1, L1-2, and L1-3 from the data I/O queue 126 and may transmit the transmission-data including L0-0, L0-1, L0-2, and L0-3 and the transmission-data including L1-0, L1-1, L1-2, and L1-3 to the storage device 140 indicated by L0-TRN and L1-TRN). In some example embodiments, the host controller 124 may remerge data related to the first full storage logical page (i.e., L0-0, L0-1, L0-2, and L0-3) with data related to the second full storage logical page (i.e., L1-0, L1-1 L1-2, and L1-3) as one I/O request to transmit remerged data related to the full storage logical pages (i.e., L0-0, L0-1, L0-2, L0-3, L1-0, L1-1, L1-2, and L1-3) to the storage device 140. Subsequently, when the third write-request WREQ3 for L2-2 and L2-3 is generated by the file system 122, where a size of the third write-request WREQ3 for L2-2 and L2-3 is two times as big as the size of the host logical page, the host controller 124 may store write-data related to the third write-request WREQ3 for L2-2 and L2-3 in the data I/O queue 126. Here, since a third full storage logical page (i.e., L2-0, L2-1, L2-2, and L2-3) exists in the data I/O queue 126, the host controller 124 may fetch the transmission-data including L2-0, L2-1, L2-2, and L2-3 from the data I/O queue 126 and may transmit the transmission-data including L2-0, L2-1, L2-2, and L2-3 to the storage device 140 (i.e., indicated by L2-TRN). In brief, the host controller 124 using the data I/O queue 126 may reduce the number of times the transmission-data is transmitted to the storage device 140 (e.g., five times in FIG. 2A and three or two times in FIG. 2B) and may prevent a plurality of write-requests from being sent to the storage device 140 to complete a write operation performed on the same storage logical page of the storage device 140. As a result, overall performance of the storage system 100 may be enhanced and a lifetime of the storage system 100 may be lengthened. In addition, the number of tunes a full merge operation is performed by a flash translation layer may be reduced when a garbage collection operation is performed by the flash translation layer.

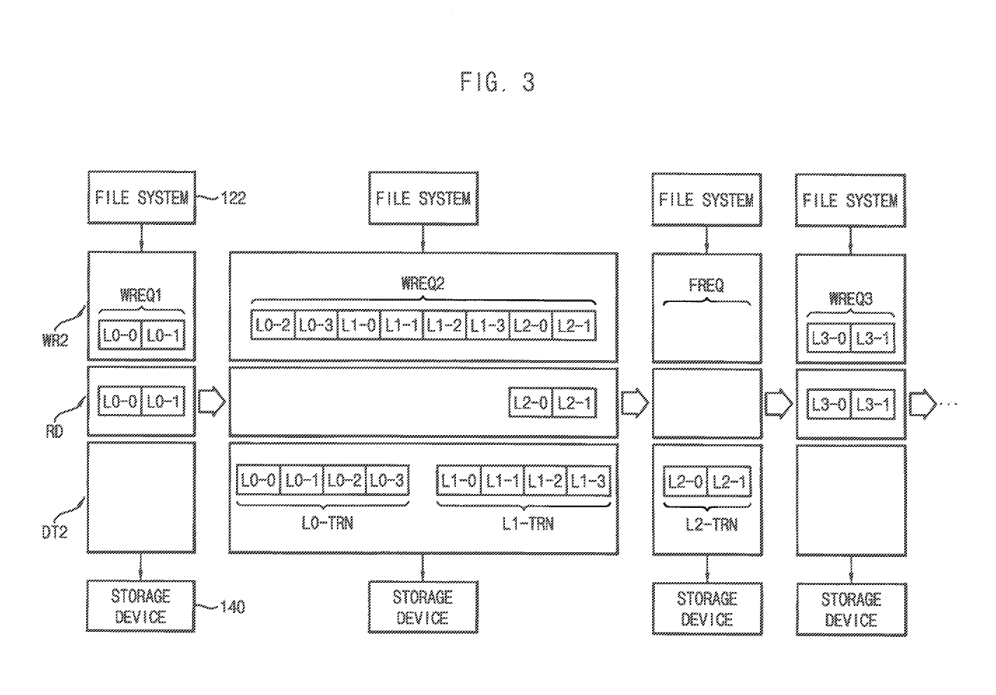

FIG. 3 is a diagram illustrating an example in which a host controller operates in response to a flush-request generated by a file system in the storage system of FIG. 1.

Referring to FIG. 3, it is illustrated in FIG. 3 that the host controller 124 processes a flush-request when the file system 122 generates the flush-request.

As illustrated in FIG. 3, the host controller 124 may receive a write-request from the file system 122 and may store write-data related to the write-request in the data I/O queue 126. Then, the host controller 124 may transmit transmission-data to the storage device 140 when storage-data stored in the data I/O queue 126 includes a full storage logical page or when the file system 122 generates the flush-request FREQ. In FIG. 3, WR2 denotes the write-data related to the write-request generated by the file system 122, DT2 denotes the transmission-data transmitted to the storage device 140, and RD denotes the remaining-data stored in the data I/O queue 126 (i.e., the storage-data) after the transmission-data is transmitted to the storage device 140. For example, in a situation illustrated in FIG. 3 (i.e., when a size of the storage logical page is four times as big as a size of the host logical page), when the first write-request WREQ1 for L0-0 and L0-1 is generated by the file system 122, where a size of the first write-request WREQ1 for L0-0 and L0-1 is two times as big as the size of the host logical page, the host controller 124 may store write-data related to the first write-request WREQ1 for L0-0 and L0-1 in the data I/O queue 116. However, the host controller 124 may not transmit the write-data related to the first write-request WREQ1 for L0-0 and L0-1 to the storage device 140 because a fall storage logical page does not exist in the data I/O queue 126. Next, when the second write-request WREQ2 for L0-2, L0-3, L1-0, L1-1, L1-2, L1-3, L2-0, and L2-1 is generated by the file system 122, where a size of the second write-request WREQ2 for L0-2, L0-3, L1-0, L1-1, L1-2, L1-3, L2-0, and L2-1 is eight times as big as the size of the host logical page, the host controller 124 may store the write-data including L0-2, L0-3, L1-0, L1-1, L1-2, L1-3, L2-0, and L2-1 in the data I/O queue 126. Here, since a first full storage logical page (i.e., L0-1, L0-2, and L0-3) and a second full storage logical page (i.e., L1-0, L1-1, L1-2, and L1-3) exist in the data I/O queue 126, the host controller 124 may fetch the transmission-data including L0-0, L0-1, L0-2, and L0-3 and the transmission-data including L1-0, L1-1, L1-2, and L1-3 from the data 110 queue 126 and may transmit the transmission-data. including L0-0, L0-1, L0-2, and L0-3 and the transmission-data including L1-0, L1-1, L1-2 and L1-3 to the storage device 140 (i.e., indicated by L0-TRN and L1-TRN). In some example embodiments, the host controller 124 may remerge data related to the first full storage logical page (i.e., L0-0, L0-1, L0-2, and L0-3) with data related to the second full storage logical page (i.e., L1-0, L1-1, L1-2, and L1-3) as one I/O request to transmit rernerged data related to the full storage logical pages (i.e., L0-0, L0-1, L0-2, L0-3, L1-0, L1-1, L1-2, and L1-3) to the storage device 140. Subsequently, when the host controller 124 receives the flush-request FREQ generated by the file system 122, the host controller 124 may fetch all remaining-data including L2-0 and L2-1 from the data I/O queue 126 and may transmit the remaining-data including L2-0 and L2-1 to the storage device 140 (i.e., indicated by L2-TRN). Next, when the third write-request WREQ3 for L3-0 and L3-1 is generated by the file system 122, where a size of the third write-request WREQ3 for L3-0 and L3-1 is two times as big as the size of the host logical page, the host controller 124 may store write-data related to the third write-request WREQ3 for L3-0 and L3-1 in the data I/O queue 126. However, the host controller 124 may not transmit the write-data related to the third write-request WREQ3 for L3-0 and L3-1 to the storage device 140 because a full storage logical page does not exist in the data I/O queue 126. In this embodiment, when the flush-request FREQ is generated by the file system, the host controller 124 may use a space of a new storage logical page (i.e., may skip a space of the previous storage logical page related to the second write-request WREQ2) in response to the third write-request WREQ3 for L3-0 and L3-1 generated by the file system 122 although the space of the previous storage logical page related to the second write-request WREQ2 (e.g., a space for L2-2 and L2-3) is available. This is to prevent a full merge operation from being performed by a storage controller of the storage device 140. In other words, a plurality of write-requests may be sent to the storage device 140 to perform a write operation on the previous storage logical page related to the second write-request WREQ2 if the host controller uses the space of the previous storage logical page related to the second write-request WREQ2 in response to the third write-request WREQ3 for L3-0 and L3-1. However, the present inventive concept is not limited thereto.

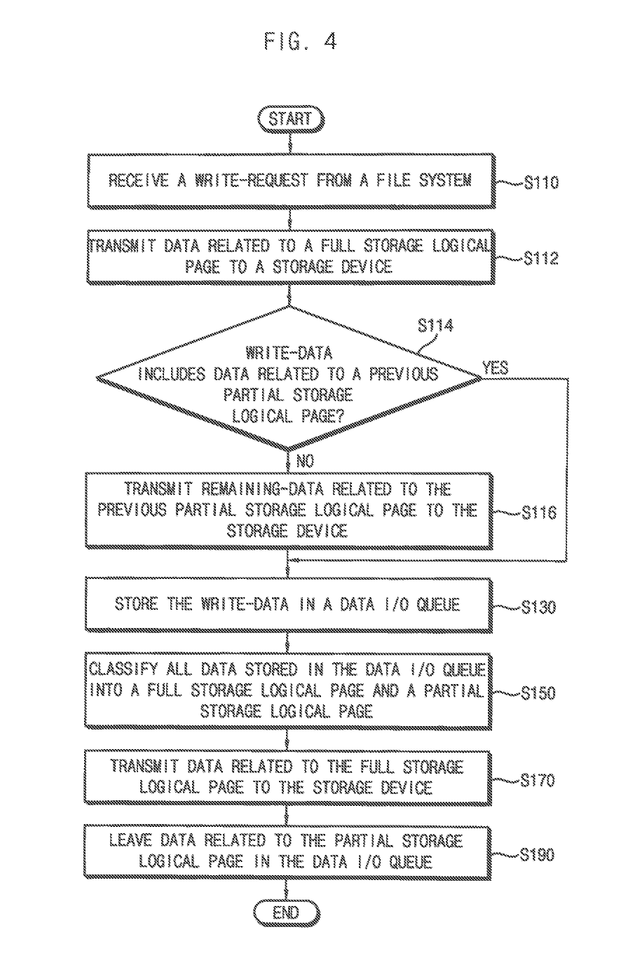

FIG. 4 is a flowchart illustrating a method of processing write-data in a storage system according to example embodiments.

Referring to FIG. 4, when a write-request is received from (or, generated by) a file system (S110), a host controller may store write-data related to the write-request in a data I/O queue (S130). Next, the host controller may classify all data stored in the data I/O queue, which include the write-data related to the write-request and remaining-data related to a previous write-request, into a full storage logical page and a partial storage logical page (S150). Here, the host controller may transmit data related to the full storage logical page to a storage device in response to the write-request generated by the file system (S170). On the other hand, the host controller may leave data related to the partial storage logical page in the data I/O queue in response to the write-request generated by the file system (S190).

Specifically, the file system may read data by a block unit and may generate the write-request (S110). Then, the host controller may process the write-data related to the write-request generated by the file system based on a size of a host logical page to store them in the data I/O queue (S130). In some example embodiments, when the write-data related to the write-request generated by the file system includes the full storage logical page, the host controller may transmit data related to the full storage logical page to the storage device without storing the data related to the full storage logical page in the data I/O queue (S112). This is because the data related to the full storage logical page does not need to wait for a next write-request. Thus, since the data related to the full storage logical page is not stored in the data I/O queue, overall performance of the storage system may be enhanced. In some example embodiments, the host controller may check whether the write-data related to the write-request generated by the file system includes data related to a storage logical page determined as the partial storage logical page in the previous write-request (S114). Here, when the write-data related to the write-request generated by the file system does not include the data related to the storage logical page determined as the partial storage logical page in the previous write-request, the host controller may transmit the data related to the partial storage logical page to the storage device (S116) because it is very likely that write-data related to a next write-request includes no data related to the partial storage logical page. Although it is illustrated in FIG. 4 that the steps S114 and S116 are performed before the step S130 is performed, the steps S114, S116, and S130 may be performed in a random order. The host controller may classify all data stored in the data I/O queue into the full storage logical page and the partial storage logical page (S150). In an example embodiment, a storage logical page may be determined as the full storage logical page when data corresponding to an end part of the storage logical page exists in the data I/O queue. On the other hand, a storage logical page may be determined as the partial storage logical page when data corresponding to an end part of the storage logical page does not exist in the data I/O queue. In another example embodiment, a storage logical page may be determined as the full storage logical page when a size of data related to the storage logical page stored in the data I/O queue is equal to a size of the storage logical page. On the other hand, a storage logical page may be determined as the partial storage logical page when a size of data related to the storage logical page stored in the data I/O queue is smaller than a size of the storage logical page. For this operation, the host controller may compare a size of data related to a storage logical page stored in the data I/O queue with a size of the storage logical page. Subsequently, the host controller may fetch the data related to the full storage logical page from the data I/O queue and may transmit the data related to the hill storage logical page to the storage device (S170). In some example embodiments, the host controller may remerge data related to full storage logical pages as one I/O request to transmit remerged data related to the full storage logical pages to the storage device. Meanwhile, the host controller may leave the data related to the partial storage logical page in the data I/O queue (S190). In some example embodiments, when the host controller receives a flush-request from the file system, the host controller may transmit all data stored in the data I/O queue to the storage device to process data related to all write-requests.

Although a storage system and a method of processing write-data in a storage system according to example embodiments have been described with reference to FIGS. 1 through 4, those skilled in the art will readily appreciate that many modifications are possible in the example embodiments without materially departing from the novel teachings and advantages of the present inventive concept.

The present inventive concept may be applied to a storage system including a storage device (i.e., a flash memory device). For example, the present inventive concept may he applied to a storage system including a solid state drive (SSD), a secure digital (SD) card, an embedded multi media card (EMMC), etc.

The foregoing is illustrative of example embodiments and is not to be construed as limiting thereof. Although a few example embodiments have been described, those skilled in the art will readily appreciate that many modifications are possible in the example embodiments without materially departing from the novel teachings and advantages of the present inventive concept. Accordingly, all such modifications are intended to be included within the scope of the present inventive concept as defined in the claims. Therefore, it is to be understood that the foregoing is illustrative of various example embodiments and is not to be construed as limited to the specific example embodiments disclosed, and that modifications to the disclosed example embodiments, as well as other example embodiments, are intended to be included within the scope of the appended claims.

What is claimed is:

1. A method of processing write-data in a storage system, the method comprising:
storing write-data related to a write-request in a data input/output (I/O) queue when the write-request is generated by a file system;
classifying data stored in the data I/O queue into a full storage logical page and a partial storage logical page;
transmitting data related to the full storage logical page to a storage device in response to the write request; and
leaving data related to the partial storage logical page in the data I/O queue in response to the write-request.

2. The method of claim 1, further comprising:
transmitting the data related to the full storage logical page to the storage device without storing the data related to the full storage logical page in the data I/O queue when the write data includes the full storage logical page.

3. The method of claim 1 further comprising:
transmitting remaining-data related to a storage logical page that is determined as the partial storage logical page in a previous write-request to the storage device when the write-data includes no data related to the storage logical page.

4. The method of claim 1, wherein the full storage logical page is distinguished from the partial storage logical page based on a size of a storage logical page that is set by the storage device.

5. The method of claim 1, further comprising:
transmitting the data stored in the data I/O queue to the storage device when a flush-request is generated by the file system.

6. A storage system comprising:
a storage device including at least one flash memory and a storage controller that controls the flash memory based on a storage flash translation layer; and
a host device including a file system and a host controller that interacts with the storage controller,
wherein the host controller stores write-data related to a write-request in a data input/output (I/O) queue when the write-request is generated by the file system, classifies data stored in the data I/O queue into a full storage logical page and a partial storage logical page, transmits data related to the full storage logical page to the storage device in response to the write-request, and leaves data related to the partial storage logical page in the data I/O queue in response to the write-request.

7. The system of claim 6, wherein the host controller transmits the data related to the full storage logical page to the storage device without storing the data related to the full storage logical page in the data I/O queue when the write-data includes the full storage logical page.

8. The system of claim 6, wherein the host controller transmits remaining-data related to a storage logical page that is determined as the partial storage logical page in a previous write-request to the storage device when the write-data includes no data related to the storage logical page.

9. The system of claim 6, wherein the host controller distinguishes the full storage logical page from the partial storage logical page based on a size of a storage logical page that is set by the storage device.

10. The system of claim 6, wherein the host controller transmits the data stored in the data I/O queue to the storage device when a flush-request is generated by the file system.
